(19) United States
(12) Patent Application Publication
(10) Pub. No.: US 2005/0187739 A1
(43) Pub. Date: Aug. 25, 2005

(54) Method and apparatus for creating and updating maintenance plans of an aircraft

(76) Inventors: Christian Baust, Wiesloch (DE); Ferenc Peter, Walldorf (DE); Marek Poleda, Wiesloch (DE)

Correspondence Address: KENYON & KENYON, 1500 K STREET NW, SUITE 700, WASHINGTON, DC, 20005, US

(21) Appl. No.: 10/854,632

(22) Filed: May 27, 2004

Related U.S. Application Data
(60) Provisional application No. 60/546,977, filed on Feb. 24, 2004.

(51) Int. Cl. G21C 17/00; G06F 17/00

(52) U.S. Cl. 702/184; 702/182; 715/513; 715/501.1

(57) ABSTRACT

An aircraft maintenance monitoring system is provided. The maintenance system monitors the operator's compliance with various technical and safety requirements imposed by various entities such as regulatory agencies, manufacturers, operators, and the like. The maintenance monitoring system provides a data structure that configures various technical objects and maintenance tasks in a hierarchical tree using object links. Such a data structure provides dynamics and flexibility to the aircraft maintenance monitoring system. This, in turn, allows updates to be automatically incorporated to the existing maintenance plans and maintenance schedule without any duplicate operations.

This application benefits from the priority of provisional application Ser. No. 60/546,977, filed Feb. 24, 2004, the disclosure of which is incorporated herein.

Embodiments of the present invention relate to a method and system for aircraft maintenance, and more particularly, to an aircraft maintenance method and system that updates with new maintenance requirements.

Maintenance of aircraft is subject to various requirements as defined by manufacturers, regulatory agencies, and aircraft operators. These requirements may concern safety issues and/or other technical issues for various parts of the aircraft. These requirements are typically documented. Such documents include, for example, maintenance manuals, Maintenance Review Board (MRB) documents, structural repair manuals, aircraft wiring diagrams, general engineering manuals, and the like. Generally, the maintenance requirements originate from the manufacturer. When an aircraft is purchased, the owner receives various manuals and documents from the manufacturer that describe how to maintain the aircraft. These documents are often quite lengthy and complex (depending on the size of the aircraft, one document may include anywhere from 1000 to 100,000 tasks or more). Each document may include various information including, but not limited to:
maintenance labor-hours estimates for tasks;
facilities and tooling recommendations;
recommended discretionary maintenance tasks improving maintenance economics, serviceability, and the like;
administrative process and planning information, including packing strategies.

To ensure that the aircraft is in compliance with the mandatory maintenance requirements, aircraft typically is subject to routine checkups. Such a maintenance schedule is described in these documents as well. Because aircraft have many different components, some parts require checkups more frequently than others do. As is well known to those skilled in the art, maintenance tasks are grouped into four different checks—“A check,” “B check,” “C check,” and “D check.” Each letter check is subject to a routine checkup with different frequency, with the A check occurring most frequently than others. These routine checkups may take anywhere from a few hours to a few weeks.

Taking into account all of the aforementioned factors, engineers translate these documents into an operator-specific maintenance program when the maintenance requirement documents are received. These operator specific maintenance programs are then configured into job cards. The job cards are then grouped into work packages based on their maintenance schedule. Actual maintenance is performed according to the job cards on its effective date.

These requirements are, however, constantly updated as any of the above mentioned entities may deem fit. These updates may involve various parts, which may have different maintenance plans and/or maintenance schedules. Additionally, it is also common for one operator to have more than one aircraft of different manufacturer, modification levels, and models, each of which requires its own maintenance requirements to maintain its airworthy condition. Thus, the maintenance system must be smart enough to determine which aircraft will be affected by the updated maintenance requirement, how it is to be applied to different aircraft, and when. Because the operator is responsible for the airworthiness of the aircraft, it is important to have a reliable monitoring system that keeps track of all these maintenance plans and schedules as well as updates.

Today, no known system provides an aircraft maintenance system or method that copes with all of the aforementioned obstacles. Accordingly, there is a need in the art for a system and method that manages maintenance plans and schedules from various sources, and also incorporates new updates into the existing maintenance plans.

### BRIEF DESCRIPTION OF THE DRAWINGS

FIG. 1 is a block diagram illustrating functional units of an aircraft maintenance monitoring system according to an embodiment of the present invention.

FIG. 2 illustrates data flow in an aircraft maintenance monitoring system according to an embodiment of the present invention.

FIG. 3 illustrates an exemplary data structure of maintenance plans as stored in a repository of an aircraft maintenance monitoring system according to an embodiment of the present invention.

FIG. 4 illustrates a method for updating maintenance plans according to an embodiment of the present invention.

FIG. 5 illustrates processing of an update of maintenance plans with an exemplary data structure of an aircraft maintenance monitoring system according to an embodiment of the present invention.

FIG. 6 illustrates a method for updating a maintenance schedule according to an embodiment of the present invention.

FIG. 7 illustrates processing of an update of a maintenance schedule with an exemplary data structure of an aircraft maintenance monitoring system according to an embodiment of the present invention.

FIG. 8 is a simplified block diagram of a computer system.

### DETAILED DESCRIPTION

Embodiments of the present invention provide a computerized aircraft maintenance monitoring system that monitors the operator's compliance with various technical and safety requirements imposed by various entities such as regulatory agencies, manufacturers, operators, and the like. The maintenance monitoring system provides a data structure that configures various technical objects and maintenance tasks in a hierarchical tree using object links. Such a data structure provides dynamics and flexibility to the aircraft maintenance monitoring system. This, in turn, allows updates to be automatically incorporated into the existing maintenance plans and maintenance schedule without any duplicate operations.

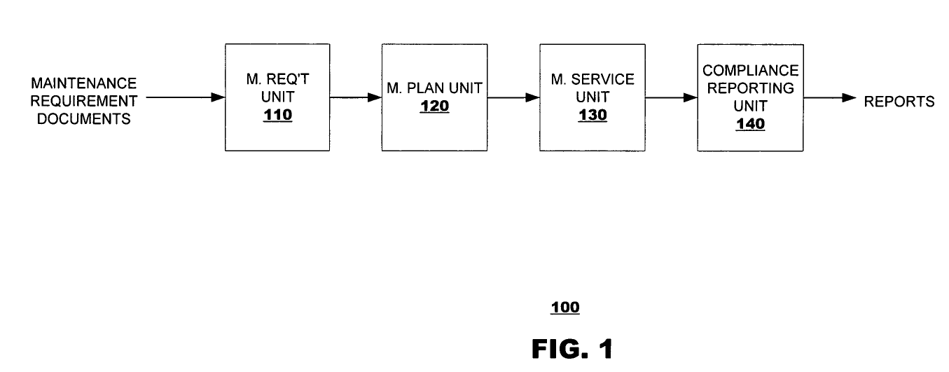

FIG. 1 is a block diagram illustrating functional units of an aircraft maintenance monitoring system 100 according to an embodiment of the present invention. The maintenance monitoring system 100 may include a maintenance requirement unit 110, a maintenance plan unit 120, a maintenance service unit 130, and a compliance reporting unit 140. The maintenance requirement unit 110 may receive documents that detail maintenance requirements. The maintenance plan unit 120 may extract specific maintenance plans from those documents specifying maintenance requirements. The maintenance service unit 130 may monitor specific maintenance tasks that are to be performed and that are already performed. Finally, the compliance reporting unit 140 may report to regulatory agency the status of the maintenance tasks to comply with the maintenance requirements.

Particularly, the maintenance requirement unit 110 may receive documents that detail maintenance requirements. As previously mentioned, these documents may come from various sources such as the aircraft manufacturer, regulatory agencies, and the operator. Some maintenance requirements may come from the original documents received when the aircraft is purchased, or some may be updates to the existing maintenance plans. These documents may include Maintenance Review Board (MRB), Maintenance Planning Documents (MPD), Service Bulletins (SB), Airworthiness Directives (AD), and the like. Because these documents come from different sources, they may be in various formats regardless of whether they are in an electronic format or on paper. When the document is received, an engineer may review the document, and manually extract the maintenance requirements, which include all technical and safety requirements that must be performed.

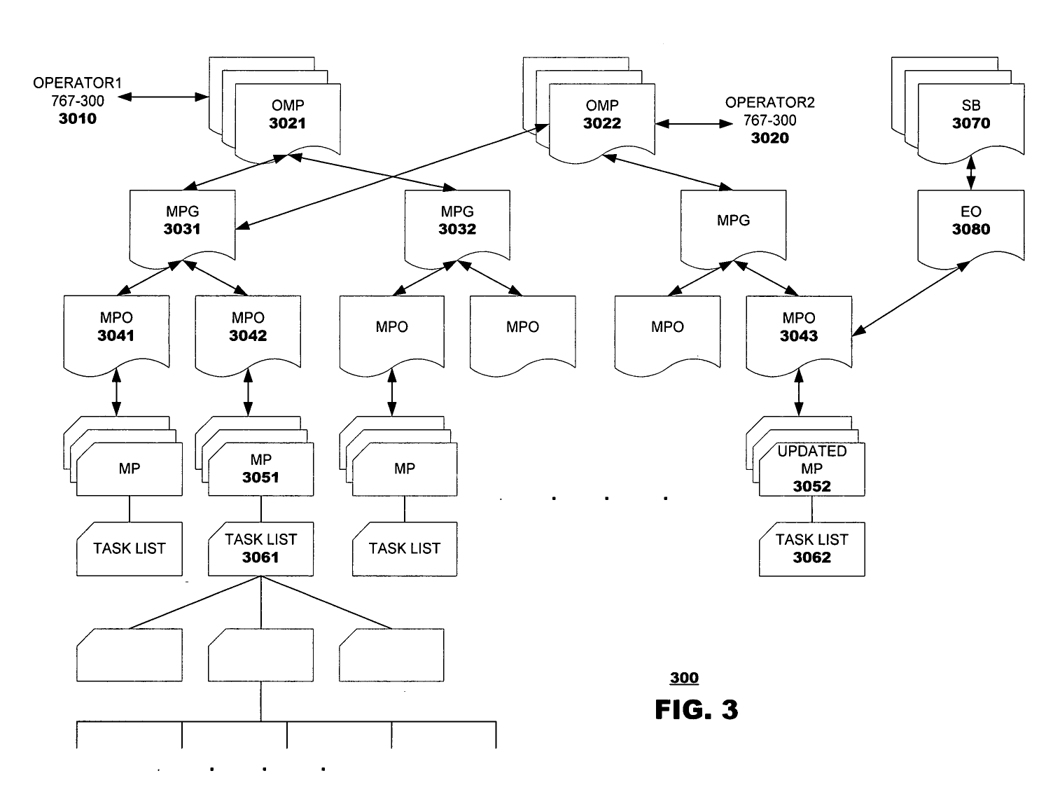

The maintenance plan unit 120 may receive the maintenance requirements from the maintenance requirement unit 110 and generate various individual maintenance plans therefrom. Each maintenance plan may describe a technical object that is involved, a task(s) to be performed, and how often the task(s) must be repeated. According to an embodiment of the present invention, each maintenance plan may involve one technical object of the aircraft. As will be apparent to those skilled in the art, a maintenance plan may involve more than one technical object. The maintenance plan unit 120 may automatically generate maintenance plans if the document is in a recognized format. If the document is in an unrecognized format or in a paper format, an engineer may review the document, extract the maintenance requirements, generate the maintenance plans, and manually enter them into the maintenance system 100. Additionally, one maintenance plan may be shared by one or more aircraft. In such cases, variables in the maintenance plan may be adjusted automatically or manually when the same part is installed on two or more aircraft. Once the individual maintenance plans are generated, each plan is assigned to an effective date, and is then stored in a repository. The repository can be organized in any manner that is intuitive for those who work with the maintenance monitoring system 100. An exemplary data structure is described below with reference to FIG. 3.

The maintenance service unit 130 may schedule execution of the maintenance plans. The maintenance service unit 130 may alert the operator of any upcoming maintenance plans to be performed. According to an embodiment of the present invention, the maintenance service unit 130 may alert the operator of all maintenance plans having a certain effective date when they become due. The timing and frequency of the alerts may be set up as desired by the operator. For example, the maintenance service unit 130 may alert the operator of future maintenance plans a month in advance if any parts to be orders, or may alert the operator once on the effective date. The maintenance service unit 130 may also monitor the history of the maintenance plans as they are performed. To do so, the operator may enter data into the maintenance service unit 130 as the maintenance plans are executed. In this way, the maintenance service unit 130 ensures that the mandatory maintenance requirements have been satisfied.

The compliance reporting unit 140 may generate periodic reports to show compliance with the requirements. According to an embodiment of the present invention, the compliance reporting unit 140 may show three different states of maintenance requirements: (1) whether the requirement has been received, (2) whether its respective maintenance plan has been generated, and (3) whether the maintenance plan has been executed. The reports generated by the compliance reporting unit 140 may show the status of these three different states to ensure the operator's compliance with the maintenance requirements. The compliance reporting unit 140 may be implemented as desired by the operator such that the operator may designate for whom the reports are generated, the format in which the reports are to be generated, which data to include, and how often the reports are to be generated. In this way, the compliance reporting unit 140 may facilitate the operator in generating reports in various formats as required by different recipients.

Embodiments of the present invention may provide an aircraft maintenance monitoring system that accounts for all the maintenance requirements that are specified in the original maintenance documents, any changes to the existing maintenance plans, and any updates to maintenance schedules. By maintaining all the maintenance plans in one repository, the aircraft maintenance monitoring system 100 may reduce the amount of time it requires to generate maintenance plans from the various documents specifying the maintenance requirements, and avoids duplicate operation of the maintenance tasks. The maintenance monitoring system 100 also may provide a consolidated view on the status and completeness of an aircraft's maintenance process.

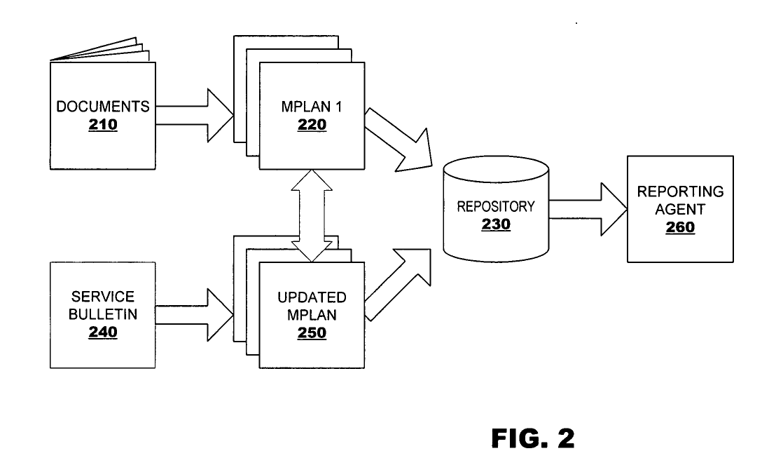

FIG. 2 illustrates data flow in the maintenance monitoring system according to an embodiment of the present invention. As described above, the maintenance monitoring system may receive inputs from two difference sources: (1) the original documents received when an aircraft is purchased, and (2) the updates to the existing maintenance plans/schedule or any additional requirements. For the original documents 210, the engineers may create a plurality of individual maintenance plans 220 for various technical objects of the aircraft based on the operator's previous experience or specific requirements described in the documents. Each maintenance plan may contain a task list that describes tasks to be performed in detail. The maintenance plans may then be stored in a repository 230.

The updates may define a change to an aircraft configuration and/or a change to the existing maintenance plans. The documents specifying the updates 240 may be received from a service bulletin issued by the manufacturer, or when an operator wants to enhance the operator's maintenance plans. Usually, compliance with the service bulletin is also mandated by the aviation authority in the form of an Airworthiness Directive (AD). When the documents specifying the updates 240 are received, the maintenance monitoring system may create an updated maintenance plan 250 by using the planning data that are used to create maintenance plans. Alternatively, the updated maintenance plan 250 may be generated by updating the existing maintenance plan according to the changes to be made as specified in the updates document 240. The updated maintenance plan 250 may be linked to the original maintenance plan 220 so that execution of both the original and updated maintenance plans can be avoided. The updated maintenance plans 250 may then be stored in the repository 230 as well.

Each maintenance plan may be accorded an effective date and a status as to whether it is to be performed or was performed. The maintenance monitoring system may alert the operator of specific maintenance plans as they become due. The operator may change the status of a particular maintenance plan as they are performed. A reporting agent 260 may report the status of the maintenance plans as desired by the operator.

FIG. 3 illustrates an exemplary data structure 300 of maintenance plans as stored in a repository of an aircraft maintenance monitoring system according to an embodiment of the present invention. The maintenance system may configure the maintenance plans to define various hierarchical tree structures. In this example, the system may monitor two aircraft of the same type, Boeing 767-300, operated by two different operators: Operator1 3010 and Operator2 3011. When these aircraft are purchased, the original maintenance documents are received. The engineers may then transform the original documents into operator's maintenance program documents (OMP) 3021, 3022. The OMPs 3021, 3022 are modified original documents that describe the fleet level of the aircraft. Such modifications may be based on the operator's previous experiences or specific requirements described in the original documents. According to an embodiment of the present invention, one OMP 3021, 3022 is created for each aircraft. More than one aircraft may be assigned to a single OMP.

Each OMP 3021, 3022 may be “linked” to one or more maintenance program group documents (MPG) 3031, 3032. The MPG document 3031, 3032 may define a bridge between the OMP and a maintenance plan object document (MPO) 3041, 3042, which is described below. The MPG may be a grouping object that groups requirements based on a certain similarity. For example, grouping may be done using, but not limited to, spatial, technical, or functional criteria. Each OMP 3021, 3022 may have as few or many MPGs 3031, 3032 as desired. One MPG 3031, 3032 may also be shared by one or more OMPs 3021, 3022.

Each MPG 3031, 3032 may be linked to a plurality of MPOs 3041, 3042. The MPO 3041, 3042 may describe specific tasks to be performed and their scheduling parameters. Each MPO 3041, 3042 may be linked to one or more OMPs 3021, 3022 via the MPG to facilitate simultaneous maintenance of several aircraft of the similar type. In such a case, the aircraft part related to the MPO 3041, 3042 may be installed in both aircraft. Hypothetically, two different model aircraft may use the same landing gear. In such a case, the MPO 3041, 3042 representing the landing gear may be shared by both aircraft.

From the MPO 3041, 3042, maintenance plans (MP) 3051 may be generated with an assigned task list 3061. According to an embodiment of the present invention, each MP 3051 may represent one technical object. One MPO document 3041, 3042 may be linked to as few or many maintenance plans 3051 as desired. The number of MPs created per one MPO document 3041, 3042 may depend on how many equipment exist in one MPO, and how many MPs are shared with another MPO. Each MP may have an assigned task list 3061, which describes the actual operations in detail. Each task in the task list may involve a subpart of the technical object related to the MP 3051. The same task list may be shared by more than one MPs 3051.

The maintenance monitoring system also may include updated maintenance plans in the hierarchy tree structure 300. When an update is received from either a service bulletin 3070 and/or an operator, the maintenance monitoring system may determine which MPO 3041-3043 may be affected by this update. The system then may further determine specific tasks that must be performed as required by the update, and create an engineering order (EO) 3080. The EO 3080 may define a change to an aircraft configuration or a change to the maintenance program definition. The EO 3080 may then be linked to an MPO 3043 that is to be affected by the update. Once it is linked to the MPO 3043, the maintenance system may then check for its effects on existing maintenance plans 3052—i.e., which of the existing maintenance plans 3052 may be affected by the update. Thus, creation of this object link between EO 3080 and MPO 3043 may trigger the update of data stored in its respective MPs 3052. The changes to the MPO 3043 may be definitive. Thus, the related entry in its task list 3062 and each operation may automatically be updated.

According to an embodiment of the present invention, a hierarchical data structure shown in FIG. 3 may provide a direct link between the OMP and the task list. This may allow tracking of the related objects from the OMP level to the specific task level, and vice versa. Thus, if a new task is required, only one task in the task list needs to be updated. The system will then determine which other tasks in the task list and/or maintenance plans may be affected by the update, and automatically update those affected tasks/maintenance plans. Additionally, the object links between various documents may also provide dynamic data structure that may be flexibly changed depending on the configuration, modification status, and the like. Further, the object links may allow for discarding tasks that are not relevant to a specific maintenance occurrence. This, in turn, may prevent duplicate operations of the same maintenance task and reduce waste of resources.

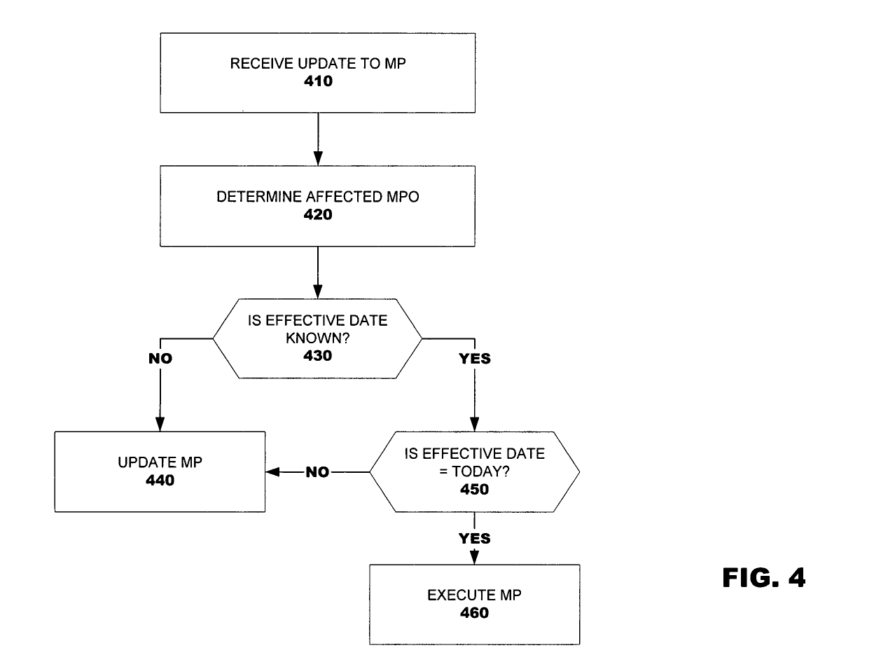

FIG. 4 illustrates a method for incorporating an update to a maintenance plan according to an embodiment of the present invention. When the update is received (box 410), each MPO may be examined to determine if the MPO document is affected (box 420). If the MPO is affected by the update, then the system may determine which of the MPs associated with the MPO is affected by the update. For each MP affected by the update, the system may look for an effective date (box 430). If the effective date is not known, the respective maintenance plans may be automatically updated (box 440). If the effective date is known (box 430), then the system may determine if the effective date of the maintenance task is today (box 450). If the effective date is today, then the update may be executed without incorporating it into the document (box 460). If not, the update is incorporated into the existing maintenance plan (box 440). In such instances, the update may be executed at a later date as scheduled.

As mentioned before, the changes made in an MPO are definitive. Thus, when the MPO is changed, its related maintenance plans and assigned task lists are updated as well.

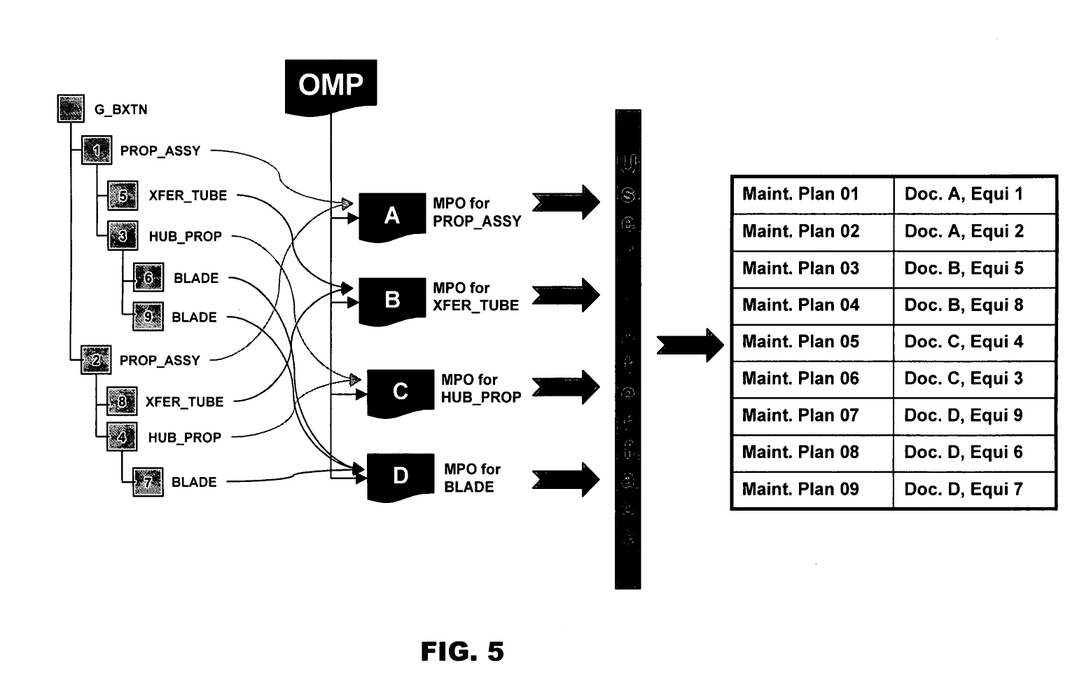

FIG. 5 illustrates processing of an update of a maintenance plan with an exemplary data structure of a maintenance monitoring system according to an embodiment of the present invention. In this example, one OMP is linked to four MPOs. The four MPOs may include: MPO A for a propeller assembly, MPO B for a transfer tube, MPO C for a hub propeller, and MPO D for a blade. Each MPO may be linked to a plurality of MPs, especially if the maintenance monitoring system monitors two aircraft that use the same part as shown in FIG. 3. Consider an update received from the service bulletin that calls for an update on MPO C. The system may determine which MPO is affected by this update. Once the affected MPO, or MPO C, is determined, the system may create an EO and create a link to the MPO C. The maintenance system may then determine which MPs are linked to the MPO and determine if each MP is affected by the update—i.e., MP 05 and MP 06 in the example illustrated in FIG. 4. The changes may then be automatically made to the MPs that are to be affected by the update.

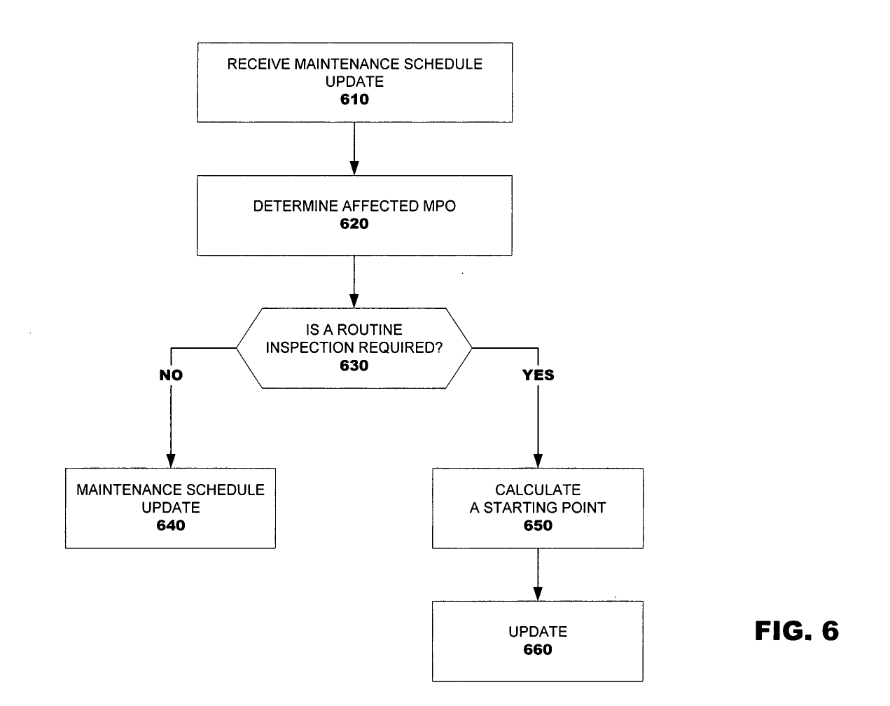

FIG. 6 illustrates a method for incorporating an update to a maintenance schedule according to an embodiment of the present invention. The inspection of the component or execution of a certain maintenance plan is typically scheduled on a regular basis. Such a maintenance plan may be modified at anytime by a service bulletin or by the operator's choice. In this case, the update of the maintenance plan may be done in sync with the then existing report of the maintenance plan. Therefore, when an update to a maintenance schedule is received (box 610), each MPO may be examined to determine if the MPO document should be changed (box 620). If the MPO is affected by the update, then the system may determine whether a routine inspection is required (box 630). If not, the update to a maintenance schedule is incorporated (box 640). If so, the system may calculate a “starting point” to reschedule the inspection dates (box 650). The starting point may be calculated based on the status of the maintenance plan—i.e., whether the maintenance is being executed; if so, when was the last inspection date, and the like. With reference to the starting point, the update to the maintenance schedule is then incorporated (box 660).

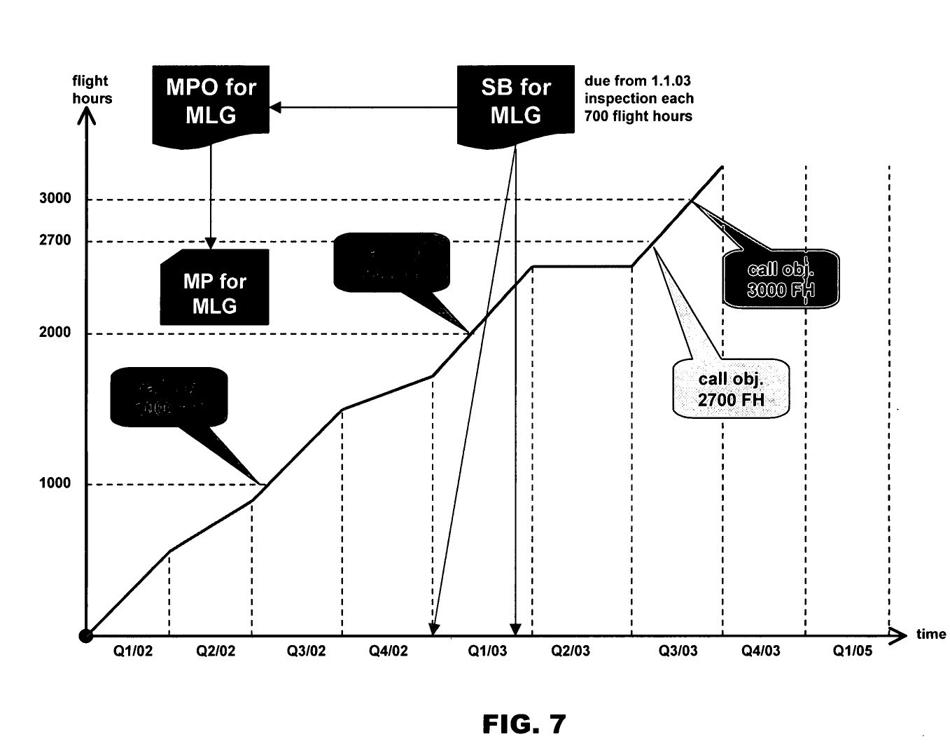

FIG. 7 illustrates processing of an update of a maintenance schedule with an exemplary data structure of a maintenance monitoring system according to an embodiment of the present invention. In this example, the MPO is for a landing gear that has been in service since January 2002, and the inspection is scheduled for every 1000 flight hours. Suppose a service bulletin issued by the landing gear manufacturer after one year, which changes the inspection interval to every 700 flight hours. Also, assume that the update is effective as of January 2003. When the update is received, the system may determine which MPO is affected by this update. Once located, the system may create an EO and create a link to the MPO for the landing gear. The maintenance system may then determine which MPs are linked to the MPO and which MP is affected by the update. The system may then determine a starting point—i.e., when the aircraft was last inspected: 2000 flight hours. The system may adjust the inspection schedule with respect to the starting point. According to the old maintenance plan, the next inspection is scheduled at 3000 flight hours, which would be approximately in September 2003. As the maintenance plan is modified, the next inspection may be due at 2700 fight hours, which would be approximately in July 2003. From this point, the inspection will be performed every 700 fight hours until the MPO is modified again.

Embodiments of the present invention therefore provide an aircraft maintenance monitoring system that allows for changes to the existing maintenance plans/schedules to be automatically updated. Due to the object dependency, the present invention facilitates tracking of the related objects within the hierarchical data structure. This, in turn, allows changes to be made at any level in the data structure and related objects to be automatically updated when one of the objects is changed. Embodiments of the present invention thus provide for a fully automated aircraft maintenance management system and speeds up the update process of the existing maintenance plans/schedules.

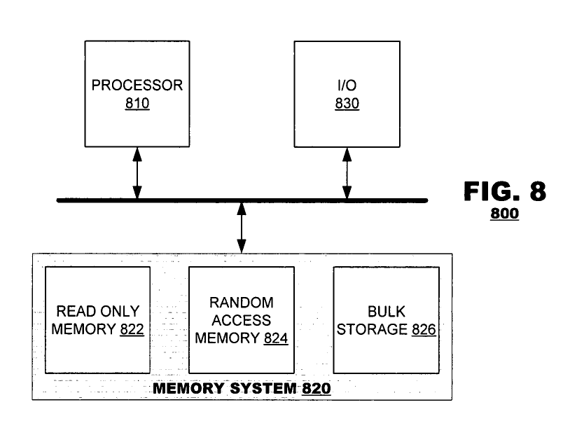

The foregoing embodiments may provide a software-implemented system. As such, these embodiments may be represented by program instructions that are to be executed by a server or other common computing platform. One such platform 800 is illustrated in the simplified block diagram of FIG. 8. There, the platform 800 is shown as being populated by a processor 810, a memory system 820 and an input/output (I/O) unit 830. The processor 810 may be any of a plurality of conventional processing systems, including microprocessors, digital signal processors and field programmable logic arrays. In some applications, it may be advantageous to provide multiple processors (not shown) in the platform 800. The processor(s) 810 execute program instructions stored in the memory system. The memory system 820 may include any combination of conventional memory circuits, including electrical, magnetic or optical memory systems. As shown in FIG. 8, the memory system 820 may include read only memories 822, random access memories 824 and bulk storage 826. The memory system 820 not only stores the program instructions representing the various methods described herein but also can store the data items on which these methods operate. The I/O unit 830 would permit communication with external devices (not shown).

Throughout the foregoing description, several examples are provided in the context of an aircraft maintenance monitoring system that monitors two aircraft of the same type. These examples have been used with an expectation that doing so makes it easier to explain the principles of the present invention to a lay audience. As will be apparent to one skilled in the art, the principles of the present invention also find application in such embodiments that use hundreds of aircraft that are of different types and models.

Several embodiments of the present invention are specifically illustrated and described herein. However, it will be appreciated that modifications and variations of the present invention are covered by the above teachings and within the purview of the appended claims without departing from the spirit and intended scope of the invention.

1. An aircraft maintenance monitoring system, comprising:
a maintenance plan unit to receive a maintenance document describing maintenance requirements and an update document describing an update to one of the maintenance requirement, the maintenance plan unit to generate maintenance plans when the maintenance documents are received and to generate updated maintenance plans by automatically updating the maintenance plans that are affected by the update when the update document is received,
a repository to store the maintenance plans and the updated maintenance plans, the maintenance plans being linked to the related updated maintenance plans.

2. The system of claim 1, further comprising a maintenance requirement unit to automatically extract the maintenance requirements from the maintenance document.

3. The system of claim 2, wherein the maintenance document is in an electronic format.

4. The system of claim 1, wherein the maintenance requirement is manually extracted from the maintenance document.

5. The system of claim 4, wherein the maintenance document is in a paper format.

6. The system of claim 1, wherein each of the maintenance plans describes a technical object at issue, an effective date, and one ore more tasks to be performed.

7. The system of claim 6, further comprising a maintenance service unit to schedule the maintenance plans according to the effective date.

8. The system of claim 1, further comprising a reporting unit to generate a report indicating the status of one or more of the maintenance plans.

9. A method for updating maintenance plans, comprising:
generating a plurality of maintenance plans related to one or more aircraft components
receiving a maintenance plan update,
determining an aircraft component to which the update is relevant;
identifying a maintenance plan that is related to the aircraft component that is affected by the update;
updating the affected maintenance plan automatically according to the update.

10. The method of claim 9, further comprising:
identifying a second maintenance plan that is related to the affected maintenance plan and is affected by the update, and
updating the second maintenance plan automatically according to the update.

11. The method of claim 10, further comprising:
for each of the maintenance plans that are affected by the update:
determining if an effective date of the affected maintenance plan is known,
if not, updating the affected maintenance plan,
if so, determining if the effective date is today:
if the effective date is today, executing the affected maintenance plan according to the update;
if the effective date is not today, updating the affected maintenance plan.

12. A method of updating a maintenance schedule, comprising:
generating a plurality of maintenance plans related to one or more aircraft components, one or more of the plurality of maintenance plans having a maintenance schedule for a routine inspection;
receiving a maintenance schedule update related to one of the maintenance plans;
determining which of the aircraft component concerns the update and which of the maintenance plans that are related to the aircraft component concerning the update are affected by the update;
updating the maintenance schedule of the affected maintenance plans.

13. The method of claim 12, further comprising:
identifying a second maintenance plan that is related to the affected maintenance plan and is affected by the update, and
updating the second maintenance plan automatically according to the update.

14. The method of claim 13, further comprising:
for each of the maintenance plans that are affected by the update:
determining if the maintenance plan calls for a routine inspection;
if not, updating the affected maintenance plan according to the update;
if so, calculating a starting point according to the maintenance schedule for a routine inspection,
updating the routine inspection maintenance schedule with reference to the starting point.

15. Computer readable medium storing program instructions that, when executed, cause an application to:
generate a plurality of maintenance plans related to one or more aircraft components,
receive an update to one of the plurality of maintenance plans,
determine which of the aircraft component concerns the update and which of the maintenance plans that are related to the aircraft component concerning the update are affected by the update;
update the affected maintenance plans automatically according to the update.

16. The medium of claim 15, further comprising:
for each of the affected maintenance plans:
determining if the maintenance plan calls for a routine inspection;
if not, updating the affected maintenance plan according to the update;
if so, calculating a starting point according to the maintenance schedule for a routine inspection,
updating the routine inspection maintenance schedule with reference to the starting point.

17. Computer readable medium storing program instructions that, when executed, cause an application to:
generate a plurality of maintenance plans related to one or more aircraft components, one or more of the plurality of maintenance plans having a maintenance schedule for a routine inspection;
receive a maintenance schedule update related to one of the maintenance plans;
determine which of the aircraft component concerns the update and which of the maintenance plans that are related to the aircraft component concerning the update are affected by the update; and
update the maintenance schedule of the affected maintenance plans.

18. The medium of claim 17, further comprising:
for each of the affected maintenance plans:
determining if the maintenance plan calls for a routine inspection;
if not, updating the affected maintenance plan according to the update;
if so, calculating a starting point according to the maintenance schedule for a routine inspection,
updating the routine inspection maintenance schedule with reference to the starting point.

19. A method for a computer system providing aircraft maintenance support, comprising:
responsive to a maintenance plan update, creating a maintenance plan object identifying an aircraft component affected by the update and parameters representative of new maintenance procedures to be performed,
storing the maintenance plan object,
identifying previously stored maintenance plan objects related to the aircraft component,
deactivating any previously stored maintenance plan objects that are supported by the created maintenance plan objects.

20. The method of claim 19, further comprising storing effective date for the created maintenance plan object, wherein the deactivating occurs after the effective date.
